(19) United States
(12) Patent Application Publication
(10) Pub. No.: US 2002/0100852 A1
(43) Pub. Date: Aug. 1, 2002

(54) Clamp restraint system

(75) Inventors: Donald H. Eason, Fort Collins, CO (US); Douglas A. Kempel, Fort Collins, CO (US); Robin R. Slaton, Fort Collins, CO (US)

Correspondence Address: Santangelo Law Office, P.C., Third Floor, 125 South Howes, Fort Collins, CO, 80521, US

(73) Assignee: Ultimate Support Systems, Inc.

(21) Appl. No.: 09/775,857

(22) Filed: Feb. 1, 2001

(51) Int. Cl. F16D 1/12; E04G 3/00; A47B 96/06

(52) U.S. Cl. 248/292.12; 248/229.2

(57) ABSTRACT

This invention relates generally to the field of restraint systems. Specifically, it relates to clamp restraint systems to achieve the restraint of a particular object, which may be particularly applicable to systems requiring the various and frequent adjustment of the clamped object. More particularly, the invention may relate to clamping systems providing force optimization and direction, facilitating varying degrees of adjustment, and coordinated or varying adjustment of multiple clamped objects within a more complex construction or framework. The invention may be particularly applicable to systems for clamping particular support elements or parts of racks, shelves, stands, or desks, and more particularly, may be particularly applicable for music instrument stands or racks, bicycle stands, and dental racks and stands.

### BACKGROUND OF THE INVENTION

This invention relates generally to the field of restraint systems. Specifically, it relates to clamp restraint systems to achieve the restraint of a particular object, which may be especially applicable to systems requiring the various and frequent adjustment of the clamped object. More particularly, the invention may relate to clamping systems providing force optimization and direction, facilitating varying degrees of adjustment, and coordinated or varying adjustment of multiple clamped objects within a more complex construction or framework. The invention may be particularly applicable to systems for clamping support elements or parts of racks, shelves, stands, or desks, music instrument stands or racks, bicycle stands, and a dental racks and stands.

Clamp restraint systems have historically taken many forms dependent upon, generally, the object to be clamped or restrained and the use or application to which the clamp system is to be applied. Traditional forms of clamps and clamp systems may have incorporated many familiar mechanical elements, such as screw fastening or clamping, cantilevered fasteners, clamp collars or manifolds, various mechanical adjustments, or the like.

One particular field in which clamp systems may be widely employed is the music industry. Particularly, the use of musical instrument stands may have required various forms of clamp restraints to support a musical instrument. The use of a music stand, shelf or rack, for example, may be particularly desirable during instrument use, instrument tuning and maintenance, and for periods of inactivity or long term storage, or the like. Traditionally, the clamp may provide varying degrees of adjustment for the musical instrument support system.

A particular need may exist, and potentially so in the music industry, for a clamping system providing for the adjustable restraint of music instruments, or the like. Clamping systems may generally be required to accommodate various particulars for proper instrument support, including instrument sizes, weight, particular playing configurations, among others. Various attempts have been made to introduce a clamp system that may provide for an adjustable and flexible system suitable for varying applications. Previous attempts may be found in U.S. patents such as U.S. Pat. No. 3,405,587 issued to Meazzi et al., U.S. Pat. No. 2,971,738 issued to Way, and Design Pat. No. 311,201 issued to Nakayama et al., each hereby incorporated by reference, wherein supporting systems are disclosed which may be directed to support for particular applications, particularly toward drum applications and the like. However, these support systems may fail, generally, to provide appropriately adjustable support systems for varying applications and for varying degrees of adjustability. Particularly, the support systems may not lend themselves to multiple adjustments of a particular support object while facilitating retention for return to other adjustments previously made to the support object.

Potentially recognizing the long felt but unmet need for a support system that provides for the desired adjustability and retention or return characteristics to allow for varying configurations and adjustments, various attempts may have been made to provide for a more adjustable and flexible system. Previous attempts may be found in the U.S. patent references U.S. Pat. No. 1,706,215 issued to Davidson, U.S. Pat. No. 3,535,976 issued to Osuga, and U.S. Pat. No. 5,272,952 issued to Hoshino, each hereby incorporated by reference. The support systems disclosed therein potentially illustrate attempts at more adjustable support systems. The particular case of U.S. Pat. No. 1,706,215, may potentially illustrate a support system directed at the coordination of multiple clamped or support objects. The patent references U.S. Pat. Nos. 3,535,976 and 5,272,952, however, may fail to provide adequately flexible systems for the adjustment of support direction, forces, or the like, for example longitudinal adjustments or rotations of the support object. These system may actually teach away from the desirable features of adjustability, potentially recognized by those in the field, of which the present invention, in preferred embodiments is directed.

Furthermore, the support systems referenced above may lack the compactness or low profile that may be desired in particular applications. Attempts in other fields of support systems may not have fully addressed the issue of compactness. Particularly, U.S. patent references U.S. Pat. No. 4,273,364 issued to de Lange, U.S. Pat. No. 4,653,782 issued to Munday, U.S. Pat. No. 3,286,963 issued to Bergman, and U.S. Pat. Nos. 4,934,635 and 4,997,148 issued to Sherman, teach, from various fields, clamping or connecting systems. These systems, however, may be directed to clamping systems which may incorporate particular separate and distinct clamp elements apart from those features that may actually surround the supported objects or may otherwise not be optional. These systems, therefore, may not provide the desired characteristics including that of a compact or low-profile support system identified in particular embodiments of the present invention.

U.S. Pat. No. 1,706,215, furthermore, may lack a desired simplicity in its operation. The adjustment of multiple support objects may require the adjustment of multiple elements of the clamp itself. U.S. Pat. No. 4,747,569 issued to Hoshino, may further illustrate a support system potentially requiring the adjustment of multiple elements within the support system to achieve multiple adjustments. Support systems such as those heretofore identified may lack a simplicity in operation for the support of multiple support objects or multiple adjustments.

Additionally, optimal clamping forces and positions, and the coordination of multiple forces and positions of support elements retained within support systems, may not have been fully addressed by past and current efforts in the field of support systems generally. In particular, the adjustment of a support object, for example to modify a particular orientation of the object, in a specific support system may require a change in multiple orientation characteristics or forces. For example, it may be desirable to adjust the axial or longitudinal position of the support object without rotating the object in a particular direction. U.S. Pat. No. 4,747,569 and the GAG head plate of MSE Studio Equipment Inc., may not allow for the retention of or return to a particular orientation or force while allowing for other adjustments of the clamped object. These references may not provide for multiple adjustment aspects with the desirable flexibility and position and force retention, or the like, that have been previously identified by those substantial efforts of past attempts in the field.

### SUMMARY OF THE INVENTION

The present inventors have recognized the potential problems associated with conventional clamp restraint systems. Accordingly, embodiments of the present invention may provide for clamping systems that may address inadequacies of previous techniques. The invention may comprise, according to particular embodiments, a support clamp and methods of clamping a support whereby adjustability and flexibility for multiple configurations and applications may be more easily accomplished. The invention may comprise, in preferred embodiments, a support clamp and methods of clamping a support whereby the system is accomplished with an ease in operation, while remaining sufficiently low-profile, and even while providing for the adjustment of a support element, or the like, without the loss of particular position, orientation, force or other configuration characteristics, or the like, during clamp adjustment. In addition, embodiments of the present invention may provide for multidirectional clamp systems. Further, the present invention may comprise embodiments particularly directed at applications such as music instrument stands or racks, shelves, desks, bicycle stands, and dental racks and stands, among other applications. Embodiments of the present invention, therefore, may even be considered as a development away from previous efforts of clamp restraint systems, both generally and as more particularly described below.

Accordingly, the invention may provide, in some embodiments, a support clamp and methods of clamping a support, and in particular alternative embodiments, a support clamp and methods of multidirectional support clamping. Additionally, in preferred embodiments, the invention may provide systems for drum rack clamping.

One object of the present invention, therefore, is to provide a clamp system embodying desirable characteristics such as adjustability and flexibility to particular applications and objects. Therefore, one goal of the present invention is to provide a clamp system such that various particulars for proper support, including support sizes, weight, particular configurations, applications, among others, may be adequately considered. Particular embodiments of the invention may have applications for, and in preferred embodiments may provide, music instrument stands or racks, shelves, desks, bicycle stands, and dental racks and stands, among other designs. One particular goal of the present invention, therefore, is the provision for clamp systems providing for multidirectional support and adjustment.

Another object of the present invention is to provide clamp systems utilizing configurations and techniques that may achieve desired efficiencies in particular applications. A goal of the present invention, therefore, is to provide clamp systems incorporating low-profile and compact configurations and techniques that may achieve desired operational efficiencies compared to conventional clamping systems. Another goal, therefore, is to provide clamp systems that allow for minimal manipulation of the system to achieve desired clamp configurations and the adjustment thereof. Additionally, another goal of the present invention is to provide, in particular embodiments, clamp systems providing for the adjustment of a support element, or the like, without the loss of particular position, orientation, force or other configuration characteristics, or the like, during clamp adjustment.

Furthermore, an object of the invention is to provide clamp systems, in various embodiments, for the potential use of the system in multi-industry clamp systems. To this end, one goal of the present invention is to provide clamp configurations and techniques that may be directed to, or provide, music instrument stands or racks, shelves, desks, bicycle stands, and dental racks and stands, among other applications.

Other objects of the invention are disclosed throughout other areas of the specification and claims. In addition, the goals and objectives may apply either in dependent or independent fashion to a variety of other goals and objectives in a variety of embodiments.

### BRIEF DESCRIPTION OF THE DRAWINGS

FIG. 1 is a perspective view of one embodiment of the present invention embodied as a multi-keyboard stand.

FIG. 2 is an second perspective view of one preferred embodiment of the present invention first depicted in FIG. 1, without the depicted keyboards of FIG. 1.

FIG. 3 is a side view of one preferred embodiment of the present invention first depicted in FIG. 1.

FIG. 4a is a perspective view of a support clamp according to one embodiment of the present invention. FIG. 4b is another perspective view of the support clamp.

FIG. 5 is a cross sectional view along A-A′ of the embodiment of the present invention depicted in FIGS. 4a and 4b.

FIGS. 6a and 6b are views of the embodiment of the present invention depicted in FIGS. 4a and 4b, depicting particular clamp elements therein. FIG. 6a is a side and partially exploded view of the embodiment of FIGS. 4a and 4b. FIG. 6b illustrate a particular function of the elements depicted in FIG. 6a, in a progressive fashion for particular elements and the resulting positional orientations.

FIG. 7 is an exploded view of one particular embodiment of the present invention.

FIG. 8 is an exploded view of an alternative embodiment of the present invention.

FIG. 9 is a frontal view of the embodiment of the present invention depicted in FIGS. 1, 2 and 3.

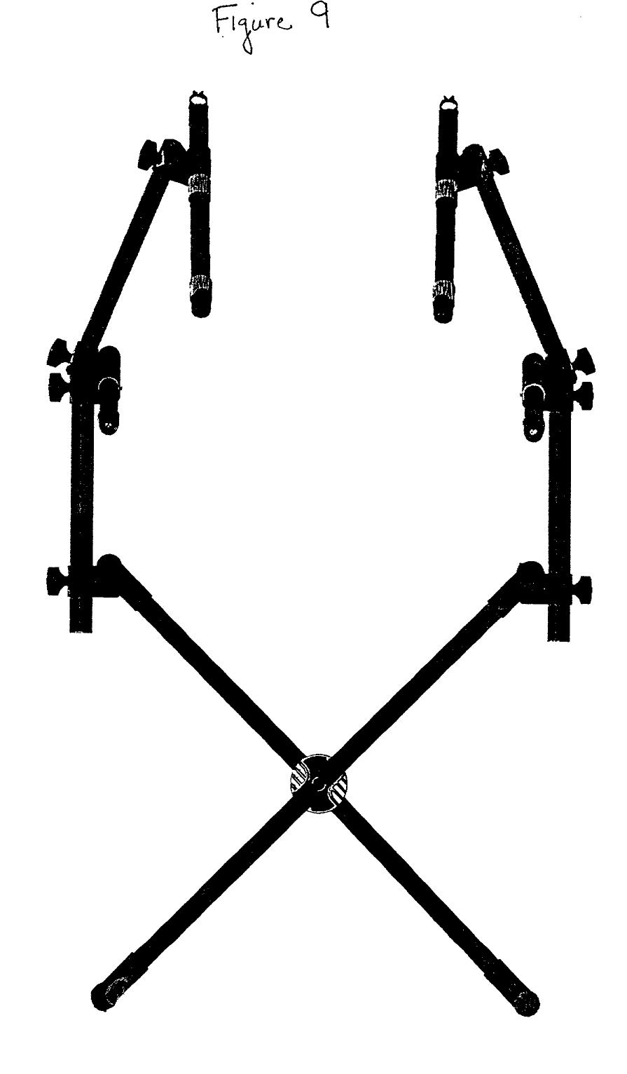

FIG. 10 is an exploded view of a particular embodiment of the present invention, illustrating, in part, the clamping of spline tubes of differing size.

FIGS. 11a-e are views of an additional design.

### DETAILED DESCRIPTION OF PREFERRED EMBODIMENTS

The basic concepts of the invention may be embodied in many different ways. The inventive concept may involve the materials, elements, apparatus, device and methods for the clamping systems and support clamps, methods of clamping a support and methods of multidirectional support clamping. While one preferred embodiment of the invention may be directed to support clamps and methods of clamping, the broad concept of the invention should be construed as a disclosure of the clamping and support in general, and as indicated, to various fields of endeavor.

As should be understood, the present invention includes a variety of aspects that may be used in various combinations depending upon the application's needs. The invention is intended to encompass a variety of embodiments of clamping systems and combinations thereof. It may involve both methods and devices to accomplish the various aspects explained. In addition, while some methods and devices are disclosed, it should be understood that these may be varied. Importantly, as to all of the foregoing, all aspects should be understood to be encompassed by this patent both independently and in combination as set forth in the claims now or later issued, in both this and in subsequent continuing applications, if any.

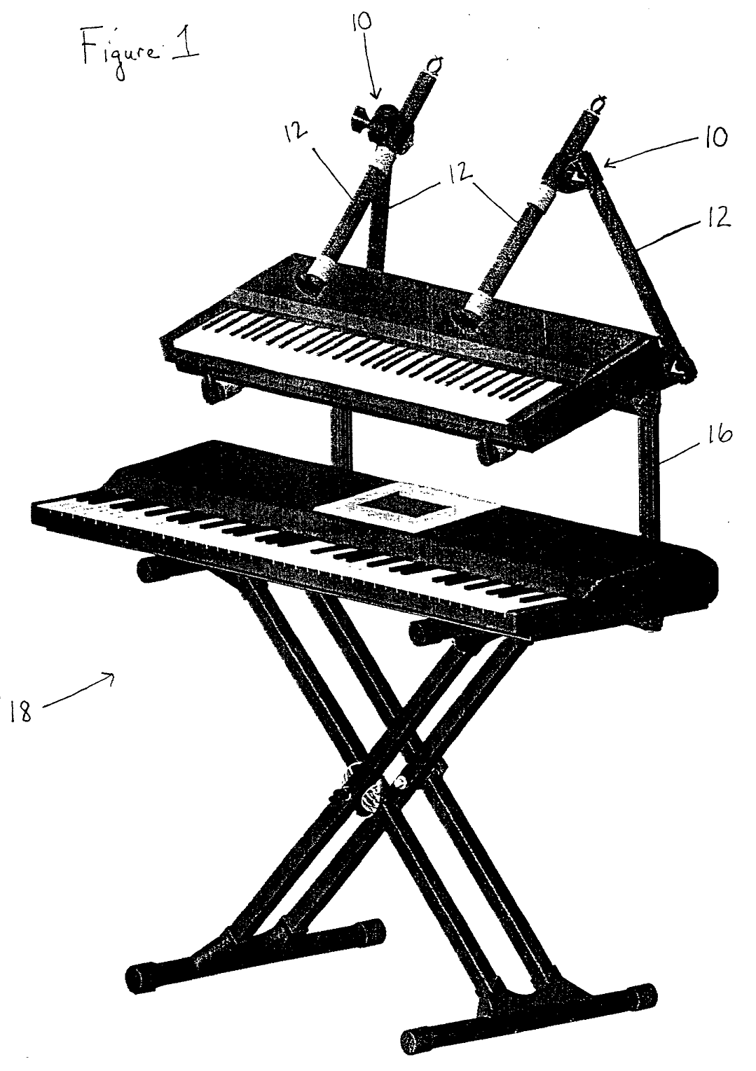

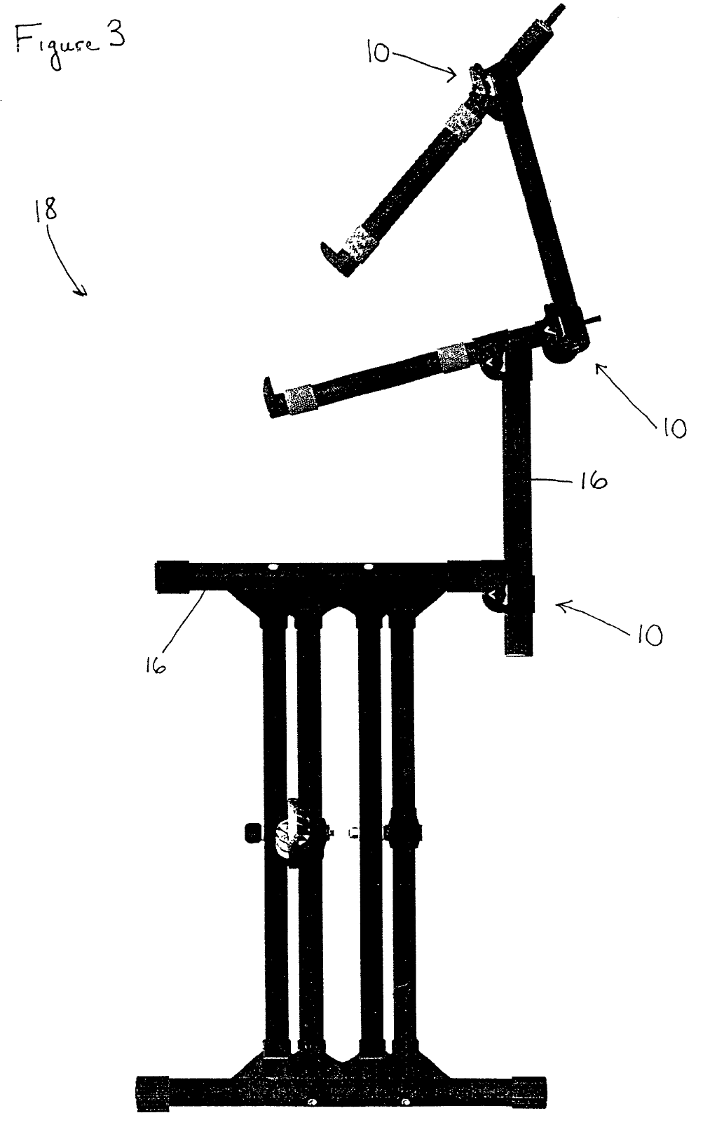

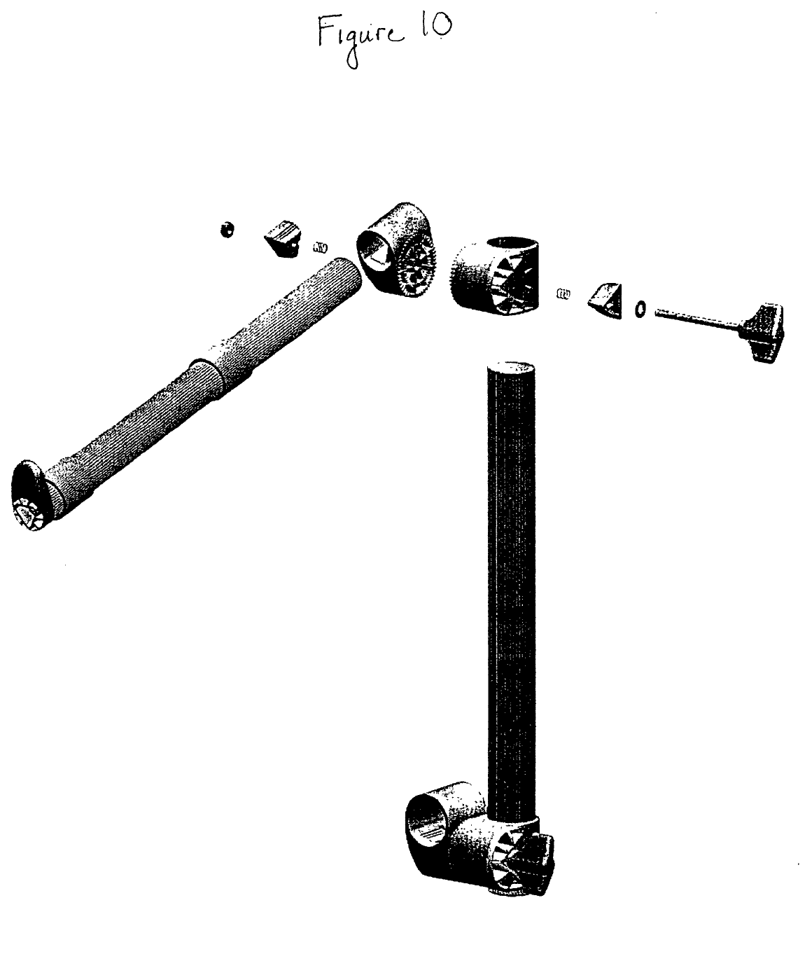

Accordingly, one embodiment of the present invention may provide for a support clamp and methods of clamping a support. In accordance with one embodiment, a support clamp (10) may be provided, and as depicted in FIGS. 1 through 3, 5, and 10, may be provided with a support element (12). In some embodiments there may be at least one support element (12), adjacent the support clamp (10), or even adjacent at least one moveable clamp element (14). As may be more particularly described herein, the support element (12) may be adjustably positioned adjacent the support clamp or adjustably positioned adjacent the moveable clamp element or elements (14).

Support element may encompass any element, object, device or apparatus, or any other clampable elements that provide, in one embodiment, an element of support used either alone or in conjunction with other elements to provide support, or the element itself may be supported, at least in part, by the support clamp (10) or any sub-elements thereof.

In accordance with some embodiments, the support elements, perhaps tubing (12), may define a larger device, framework or construction (18) which may, in accordance with preferred embodiments, comprise, either singularly or in plurality, a stand, rack, desk or shelf, and may even comprise a music instrument stand, a music instrument rack, a bicycle stand, a dental rack, a dental stand, or the like. Many such devices or constructs are fully within the disclosure of the present invention. One such device (18), in accordance with some embodiments, is depicted in FIGS. 1 through 3, potentially serving, in one embodiment, as a multi-tiered musical instrument rack, stand or shelf.

In accordance with some embodiments, the support element or elements may comprise, either singularly or as a plurality, support element (5), perhaps even tubing (12). In one embodiment, tubing (12) may have splines (16) running longitudinally, along an axial extent, or parallel along the central axis of the tubing. The spline or spline shape or form may be defined as a function that is defined on an interval, is used to approximate a given function, and may be composed of pieces of simple functions defined on subintervals and joined at their endpoints with a suitable degree of smoothness. The shape of the spline may take any perhaps repeatable form, and in accordance with some embodiments, may comprise a square or stepped function shape as depicted in the corresponding figures. Any repeatable shape, however, should be considered as disclosed herein and the present invention should not be considered limited to any common spline shape or form. The splines (16) may also be considered engaging elements serving a mechanical role for engaging with or to the clamp element or elements (14) or any other element, as described below. In some embodiments, and in accordance with the engagement function of the clamp elements (14), the clamp element or elements may provide a spline surface (62) corresponding to the plurality of splines (16) of the support members to facilitate engagement. Each of the spline elements of either spline surface (62) or splines (16) may, in particular embodiments, provide at least one spline element, which may be provided in spline shapes, as described above, and in particular embodiments, a spline tooth or ridge.

The invention may further provide, in accordance with broad particular embodiments, a restraint element (20). The restraint element (20) may, in accordance with particular embodiments of the invention, be provided either singularly or in a plurality. In accordance with some embodiments, the restraint element may be provided as two restraint elements for a particular support clamp (10). The restraint element may provide a circumscription, confinement, constraint, or other confining element or step that may secure a support element (12) or other clamped object within the clamp or during the clamp process. Other restraint elements may be considered as disclosed herein and within the scope of the present invention.

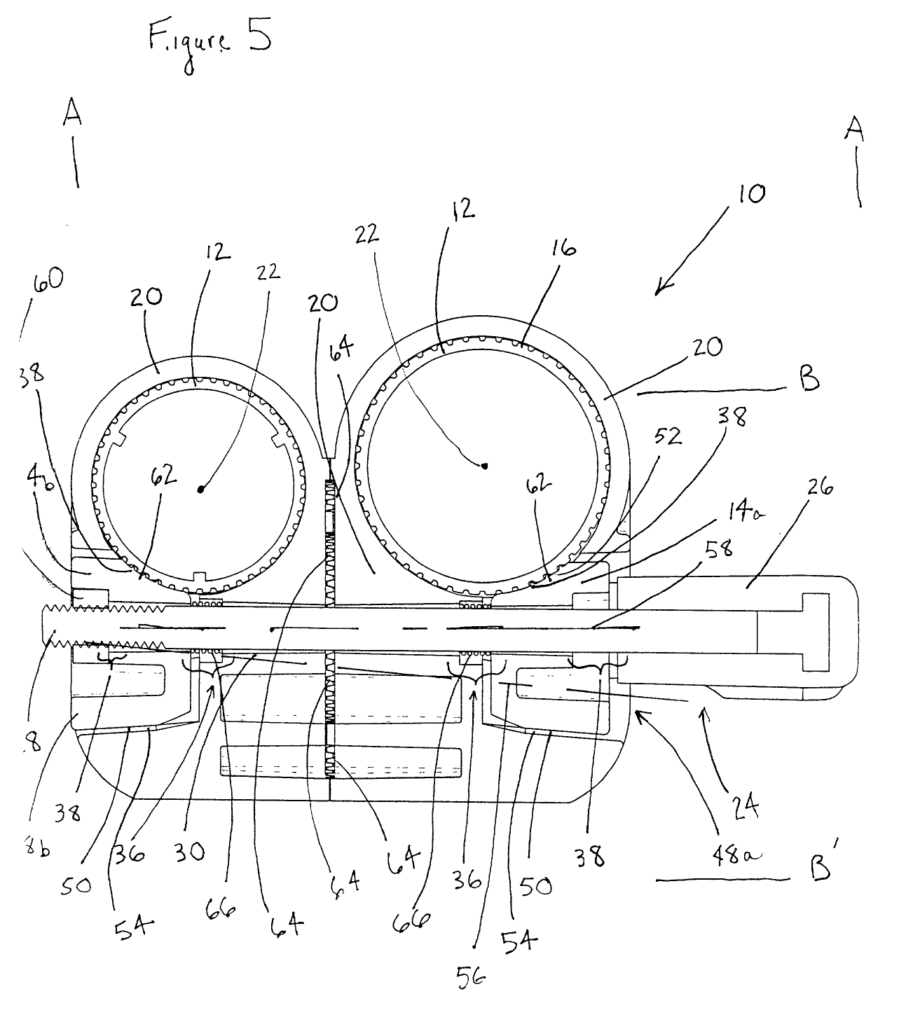

In accordance with preferred embodiments of the present invention, the restraint element (20) may be fixed. A fixed restraint element (20) may in some aspects be considered a non-moveable or non-adjustable element, or a stationary or immobile element with respect to other clamp elements, particularly adjustable or moving elements as more particularly described below. Furthermore, the restraint element (20) may comprise, in accordance with particular embodiments of the invention, a central axis (22). The central axis may serve as a point of positioning or movement for adjustable clamp elements, as more particularly described below. The central axis may, in particular embodiments, be an axis of symmetry of the fixed restraint element (20) whereby an axis of symmetry is present for each restraint element. The axis may coincide with an axis of a support element (12) within the clamp, as particularly depicted in FIG. 5. The axis may also be considered a major axis of the restraint element, and may coincide with an axis of a support element (12) within the clamp, as particularly depicted in FIG. 5.

Furthermore, the restraint element or elements (20) may, in preferred embodiments, be a unitary element. Unitary may be considered a singular piece or element which may not be easily disassembled into particular pieces or sub-elements. Unitary, as presently discussed, is described in relation to the restraint element (20) of the support clamp (10). The support clamp (10) may comprise other non-unitary elements and the restraint itself, in alternative embodiments, may comprise a non-unitary configuration. The restraint may also, in preferred embodiments, comprise a tubular restraint. The shape of the restraint may take a tubular or cylindrical form, and in preferred embodiments, may comprise a shape corresponding to the shape of the support element (12). Other shapes of the restraint may be within the broad scope of the invention, such as triangular, oval, elliptical and polygonal volumes and cross sections.

In accordance with the present invention, the support element may be positionally restrained. In accordance with one embodiment of the present invention, the support element (12) may be positioned or configured within the restraint element such that the position or configuration of the support element may be maintained by the act of restraining additional movement, positioning, or configuring of the support element (12). In accordance with preferred embodiments, the type of restraint may correspond with the restraint element (20) so that the support element may be unitarily restrained or tubularly restrained, in accordance with the particular embodiment of the restraint element. Furthermore, the support element may be substantially encompassed in the support clamp or in the clamping process. Substantially encompassed may be considered, in accordance with one embodiment of the present invention, as a clamping state or condition or form wherein a substantial portion of the support element (12) is encompassed by the restraint element such that a restraining condition of the support element may be achieved, as described above. The substantial encompassing of the support element may be accomplished with the restraint element, as a step in the clamping process, or as a state of the support element in the clamp or clamping process.

Furthermore, the present invention may provide for an adjuster or adjustment element (24), either singularly or in a plurality. The adjustment element may, in preferred embodiments, be positioned proximate the restraint element (20), providing, in part, a low-profile and compact configuration. In accordance with preferred embodiments of the present invention, the adjustment element may comprise a turn element or handle (26), and an adjustment responsive element (28), and in preferred embodiments an axially extending screw bolt (28). Furthermore, the adjustment element, in some embodiments, may be axially unrestrained in relation to the support clamp (10). In embodiments, the restraint element (20) may comprise an adjustment bore (30) perhaps providing for a screw bolt (28) to extend through the restraint elements (20), as illustrated in cross section in FIG. 5.

In accordance with some embodiments, the adjustment element (24), perhaps the screw bolt (28) may respond to an adjustment of the support clamp (10), or the clamp element or elements (14), as described below. However, the preferred embodiments may also allow for an adjustment element that is axially unrestrained with regard to the clamp adjustment process. Some embodiments may include an axially unrestrained axial adjustment element or an adjustment element which is axially unrestrained. The adjustment bore (30) may be sufficiently configured such that movement of the adjustment element (24), in some embodiments the screw bolt (28), may be allowed positioning or movement of a central or longitudinal axis of the adjustment element or the like. One embodiment may provide for non-axial or non-rotational movement of the screw bolt such that the bolt may actually torque or translate in a direction non-parallel to the adjustment bore. In one embodiment such translation may occur as a result of the positional adjustment or movement of the clamp element or elements (14), as more particularly described below.

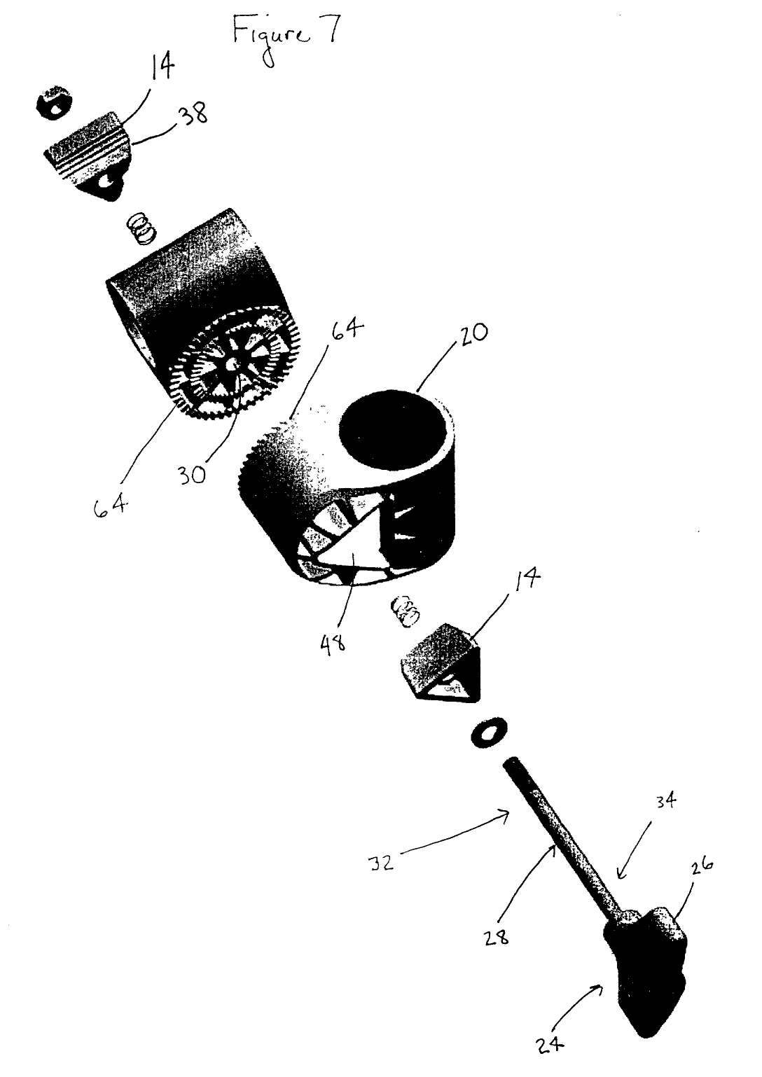

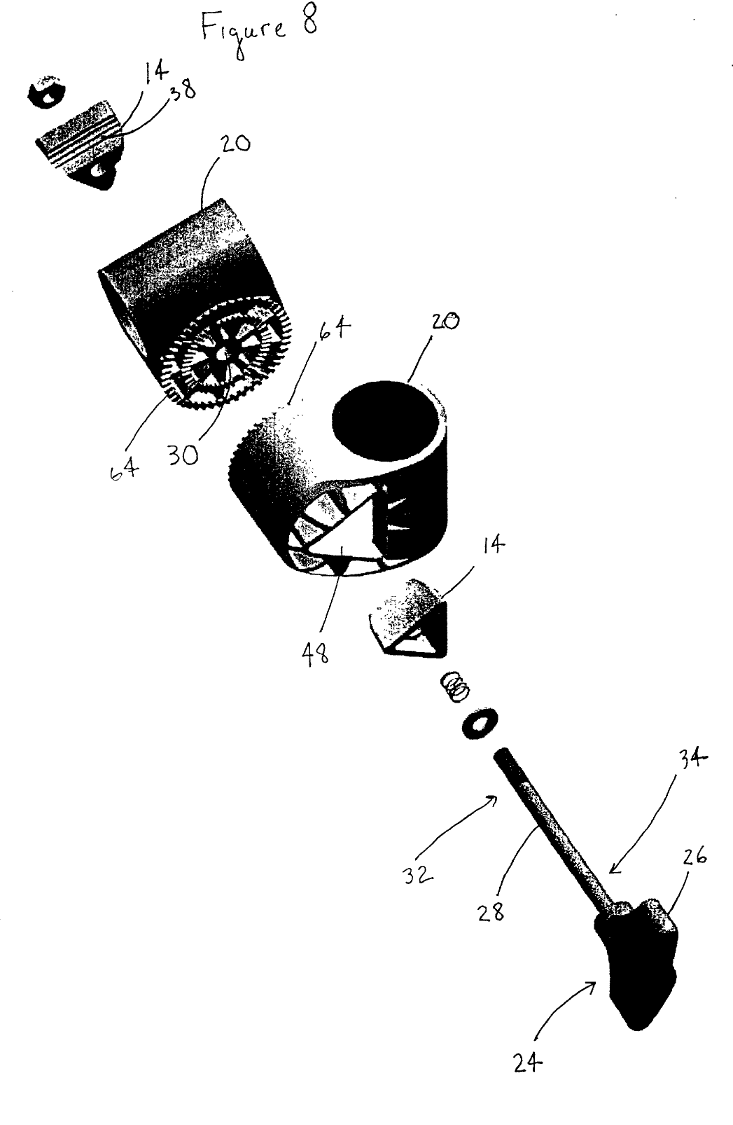

Furthermore, the adjustment element or elements (24) may provide, in some embodiments, first and second distal ends (32, 34), illustrated in FIGS. 7 and 8. These ends may be situated away from the center of the adjustment element (24), and even away from the center point of the screw bolt (28). Additionally, and as described below, particular embodiments may provide for the external positioning of an element or an element positioned external at a location or locations along the adjustment element, or even along the screw bolt and external to a point, location, area or length between the clamp element (14) and the restraint element (20). In some embodiments, the location at issue may be identified as shown in FIG. 5 as location (36). Therefore, in accordance with such embodiments, an element may be positioned external of the location (36), depicted in FIG. 5 generally as location (38), generally at distal ends of screw bolt (30) and external to location (36).

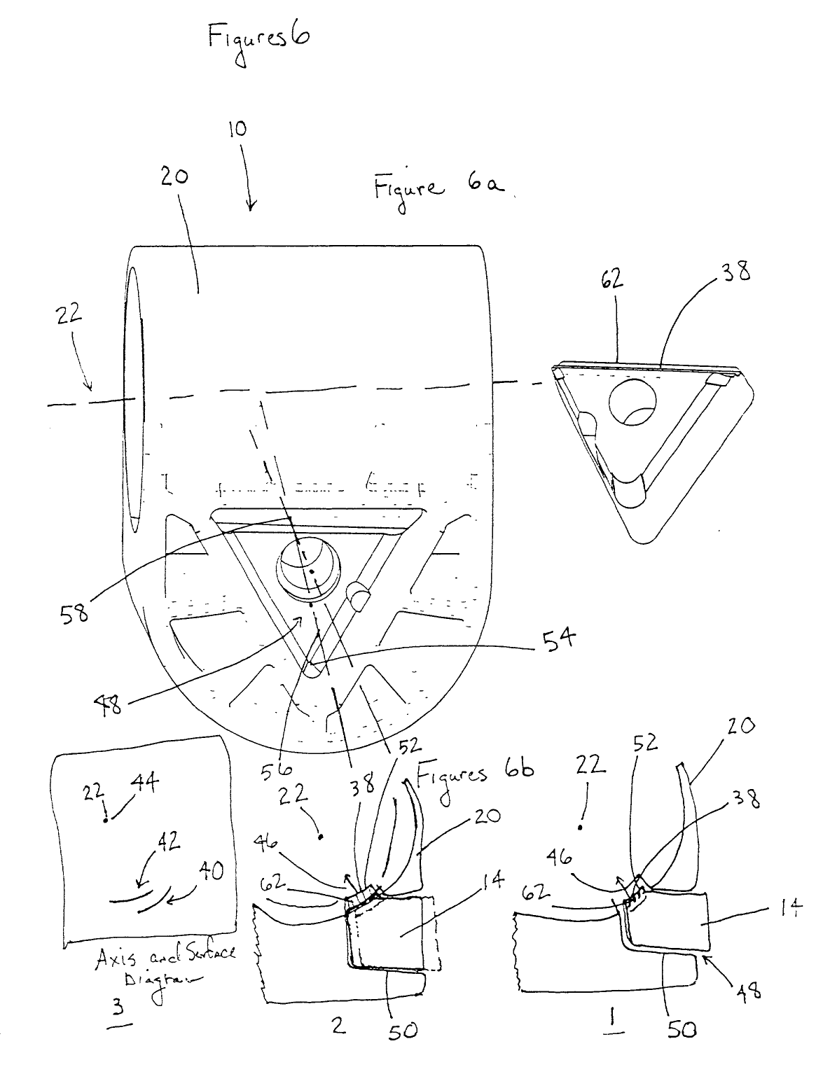

The invention may also provide clamp element or elements (14), either singularly or in a plurality. The clamp elements may serve, in particular embodiments, as the element or elements applying an adjustable force to support elements (12) and may be responsive, moveably, positionally, forcibly or otherwise, to the adjustment element or elements (24). Clamp elements (14) may comprise, in preferred embodiments, a continuously parallel surface moveable clamp element, and in particular embodiments, a continuously parallel surface (38). Continuously parallel surface (38), which may be one surface of the moveable clamp element (14) may, in preferred embodiments, maintain a continuously parallel position with respect to a central axis of the restraint element (20), and in preferred embodiments, with respect to a central axis of the support element (12). FIG. 6b may particularly illustrate the concept of a continuously parallel surface and a continuously parallel surface moveable clamp element. As more particularly described below, the continuously parallel surface moveable clamp element (14) may be adjusted such that the a continuously parallel surface (38) remains parallel to the central axis. In particular embodiments, movement of the clamp element (14) in response to the adjustment element (24) may be generally into the restraint element (20) upon an increased clamping action or response. In the second figure of FIG. 6b, moving from right to left, the continuously parallel surface (38) may be adjusted toward the central axis (22). However, and in accordance with particular embodiments, the translational movement of the clamp element (14), as more particularly described below, and the configuration or shape of the continuously parallel surface (38) maintain the parallel positioning of the face to the central axis.

More particularly, and in accordance with particular and alternative embodiments of the present invention, the surface (38) may maintain a continuously parallel position or configuration if, in preferred embodiments, a corresponding circular central axis or foci (44) of the continuously parallel surface (38) and its positional planes or arcs (40) and (42) were to preferably correspond to the central axis (22), as depicted in the third figure of FIG. 6b. Other continuously parallel configurations and surfaces may be broadly provided and supported by the disclosure herein and should be considered herein as disclosed as an inventive embodiment of the present invention. For example, the continuously parallel surface (38) may be substantially parallel to the central axis, whereby movement of the continuously parallel surface movable clamp element (14), and together with the configuration and shape of the surface (38) or distinct therefrom, the surface (38) may substantially parallel, as in a particular embodiment of the invention, wherein the corresponding circular central axis or foci (44) substantially corresponds to the central axis (22).

Furthermore, the clamp element (14) may provide an engagement direction (46). As the clamp element (14) responds to the adjustment element (24) movement of the clamp element (14) may occur such that, in preferred embodiments, the clamp element may move to engage a support element (12) within the restraint element (20). The resulting direction of motion of the clamp element (14) may provide an engagement direction as depicted in FIG. 6b.

The invention may also provide a clamp element or elements (14), either singularly or in a plurality. The clamp elements may serve, in particular embodiments, as the element or elements applying an adjustable force to support elements (12) and may be responsive, moveably, positionally, forcibly or otherwise, to the adjustment element or elements (24). Clamp elements (14) may comprise, in some embodiments, a continuously parallel surface moveable clamp element, and may include a continuously parallel surface (38). Continuously parallel surface (38), which may be one surface of the moveable clamp element (14) may, in some embodiments, maintain a continuously parallel position with respect to a central axis of the restraint element (20), and even with respect to a central axis of the support element (12). FIG. 6b may particularly illustrate the concept of a continuously parallel surface and a continuously parallel surface moveable clamp element. As described below, the continuously parallel surface moveable clamp element (14) may be adjusted such that the continuously parallel surface (38) remains parallel to the central axis. In particular embodiments, movement of the clamp element (14) in response to the adjustment element (24) may be generally into the restraint element (20) upon an increased clamping action or response. In the second portion of FIG. 6b, moving from right to left, the continuously parallel surface (38) may be adjusted toward the central axis (22). However, the translational movement of the clamp element (14), as more particularly described below, and the configuration or shape of the continuously parallel surface (38) may be designed to maintain the parallel positioning of the face to the central axis.

The surface (38) may also maintain a continuously parallel position or configuration such when a corresponding circular central axis or foci (44) of the continuously parallel surface (38) and its positional planes or arcs (40) and (42) were to correspond to the central axis (22), as depicted in the third portion of FIG. 6b. Other continuously parallel configurations and surfaces may be broadly provided and supported by the disclosure herein and should be understood as disclosed as an inventive embodiment of the present invention. For example, the continuously parallel surface (38) may be substantially parallel to the central axis, whereby movement of the continuously parallel surface movable clamp element (14), and together with the configuration and shape of the surface (38) (or distinct therefrom), the surface (38) may remain substantially parallel such as in one embodiment of the invention, wherein the corresponding circular central axis or foci (44) substantially corresponds to the central axis (22).

Furthermore, the clamp element (14) may provide an engagement direction (46). As the clamp element (14) responds to the adjustment element (24), movement of the clamp element (14) may occur such that, in some embodiments, the clamp element may move to engage a support element (12) within the restraint element (20). The resulting position of the clamp element (14), or even the surface (38), may provide an engagement direction (46) as depicted in FIG. 6b.

Additionally, in accordance with some embodiments, the clamp element (14) may comprise a clamp block or wedge. One embodiment of a clamp block or clamp wedge is depicted in the present figures as clamp element (14).

The clamp element (14) may also be forcibly responsive to a translation element (48) in a substantially radial direction of the central axis (22) of said restraint element. As depicted in FIG. 5 and FIG. 6, the clamp element may be positioned at least partially internal to the restraint element (20) and positioned adjacent the translation element (48), or even the clamp guide (48). In such a design the clamp element may be translated in response to the adjustment element (24) such that the clamp element may be translated or guided through the restraint element (20). Translation element (48) may comprise additional guide elements to facilitate the translation of the clamp element (14). In some designs, slope surface (50) may create an additional component to the clamp element's position and motion, potentially resulting in the clamp element being forcibly responsive to the translation element such that the engagement direction (46) may also serve as the direction of force response of the clamp element. The clamp block may also be forcibly responsive to the translation element in a substantially radial direction of the central axis (22) of said restraint element. Furthermore, the translation element (48) may comprise a cross section of decreasing area to effect position and motion upon clamp element (14).

The clamp element (14) may be of any shape or volume. In some embodiments, it may comprise a shape or configuration having a triangular, polygonal, circular, oval, or elliptical cross section. FIG. 6 depicts one configuration of the clamp element (14). Clamp element (14) may additionally comprise a slope or at least one slope (52) for the surface (38). The slope of surface (38) may be more particularly defined as the angle deviance of the surface (38) from some relatively fixed reference position or line. The slope may also be defined as a changing, discontinuous or interrupted slope such that one, or even potentially numerous, slopes may comprise the surface (38). Furthermore, slope (52) may correspond to a circumferential shape such as a circle, triangle, oval, ellipse or polygon, which may, in some embodiments, correspond to a shape of a support member.

The invention may also include a translation element (48). As initially described above, the translation element may have a volume having a cross section of decreasing area, which may in some embodiments correspond to the translation slope (50), which may even be considered a ramp element (54), as shown in FIG. 6a. Translation element (48) may have a volume having a cross section of decreasing area, and may have a central axis (56) which intersects an axis (58) of the adjustment element, as depicted in one embodiment in FIGS. 5 and 6a.

Translation may be effected for the clamp element or elements (14) such that the clamp element or elements are linearly responsive to the adjustment element or elements (24). Designs may provide a linear response or adjustment of the support element (14). Utilizing the adjustment element may result, in some embodiments, in translational positioning and movement along the translation element (48). Such may also provide movement along the ramp element (50). The translation element, in conjunction with the linear response provided by the adjustment element (24), such as through the axial direction of screw bolt (28), may result in a linear response of the clamp element or elements. Accordingly, the response of the clamp element may be a positional response, wherein the position of the clamp element is adjusted.

The support clamp (10), as especially depicted in FIG. 5, may comprise or accommodate the translating clamp element(s) (14), such as along the translation elements or clamp element guides (48). Adjustment by the adjustment element (24) may result in the translation of a first clamp element (14a) along a first clamp element guide (48a) and the translation of a second clamp element (14b) along a second clamp element guide (48b). In accordance with some embodiments, the rotation of the handle (26) and screw bolt (28), in conjunction with a retention member or nut (60) may result in the compression or retraction of the clamp elements (14) such that translation along the clamp element guides (48) may occur. Each clamp element may then provide a forcible response as described above. The preferred embodiment may further provide for a translation element or clamp element guide (48) having a volume with a cross section of decreasing area, as described above.

In alternative embodiments of the present invention, a support device, framework or construction (18) may be provided in accordance with the disclosure herein. More particularly, support clamps, either singularly or in a plurality, may be provided in conjunction with support elements (12) to provide a music instrument stand, a music instrument rack, a shelf, a desk, a bicycle stand, a dental rack or a dental stand, or the like. Numerous other devices, frameworks, or constructs may be envisioned through the disclosure of the present invention, and as such, should further be construed as disclosed herein.

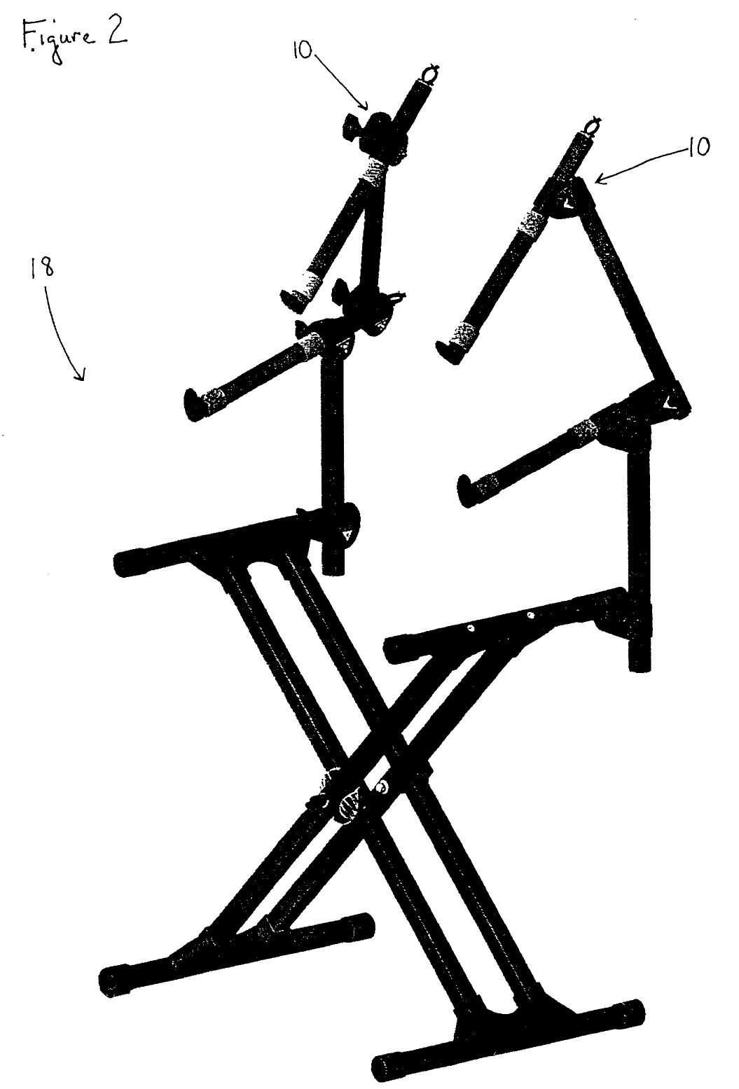

As can be easily understood, each of the restraint elements (20) may be individually angularly positioned. In particular embodiments, and initially in accordance with FIGS. 7 and 8, a plurality of index elements (64) may be provided for each restraint element. Index elements of each restraint element may correspond to an adjacent restraint element such that the restraint elements may be angularly positioned in accordance with the index elements. The index elements may also correspond to angled gradations for the angular positioning of the restraint elements. Furthermore, the indexing elements may also correspond to coordinated increments of angular positioning, wherein the restraint elements may be angularly positioned in increments that are coordinated as among the index elements of the restraint elements. This may permit like positioning among multiple supports. The index elements may also be provided as radially positioned teeth on a surface of a restraint element. FIGS. 7 and 8 illustrate potential angular positions of two restraint elements (20) in accordance with the index elements (64). FIG. 2 particularly illustrates pairs of restraint elements of support clamps (10) wherein angular positioning of paired restraint elements has been conducted.

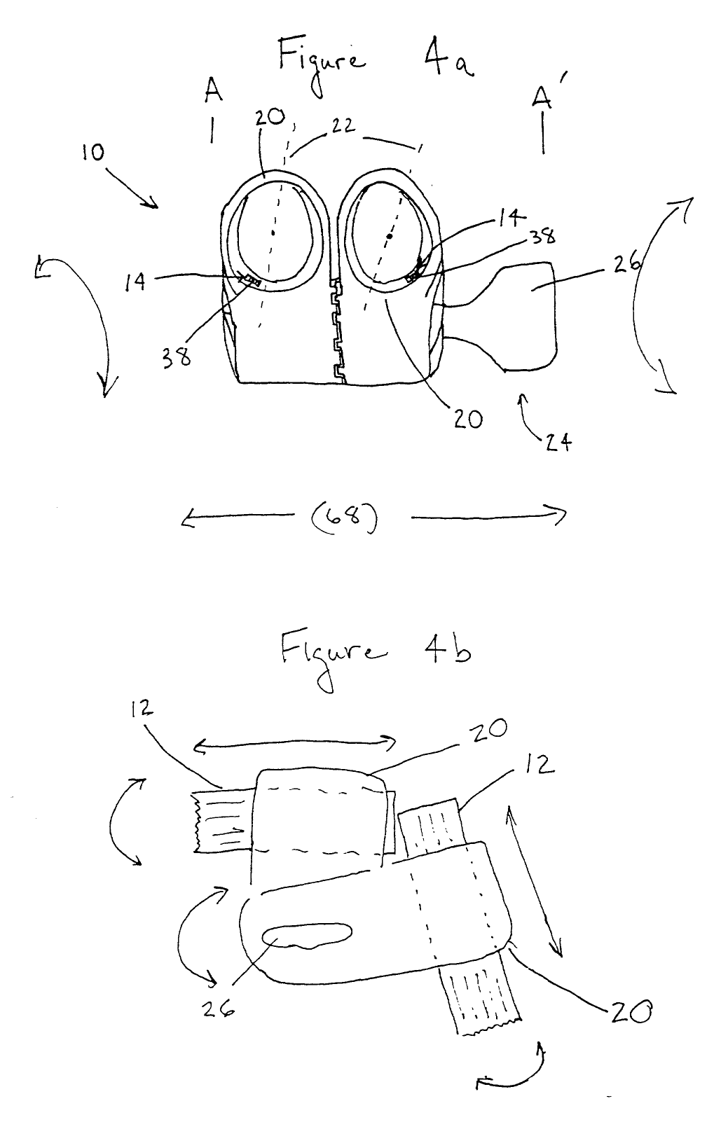

As depicted in FIGS. 4 and 5, the adjustment element (24) may be adjusted such that a separation of the two restraint elements (20) may occur. Compression springs (66), internal to the restraint elements (20) may allow for the restraint elements (20) to be returnably separated (68) such that restraint element (20) may be rotated to an appropriate individual angular position and returned to a position wherein indexing elements (64) retain the individual angular position. Accordingly, this particular embodiment of the invention can provide a first degree of position for the support clamp.

Therefore, the clamping steps of individually angularly positioning each restraint element (20) may be performed. The steps of individually angularly positioning each fixed restraint element, individually angularly positioning each support element, indexing in angle gradations, angularly indexing a position in coordinated increments, indexing in angle gradations, indexing a position of each of the fixed restraint elements in coordinated increments (including positions indexed in angle gradations and indexed in coordinated increments) may all be performed in accordance with various embodiments of the present invention.

Additionally, preferred embodiments of the present invention can provide for three, and even five degrees of positioning of the support clamp (10). In one embodiment, a support clamp having two restraint elements (20) may be angularly positioned as previously described. Furthermore, support elements restrained with each restraint element may be positioned both rotatably, as further described below, and translationally or along the central axis of each restraint element. Given the potential for two degrees of position for each of two restraint elements in the described embodiment of the present invention, and the degree of angularly positioning each individual restraint element, the present invention may provide for three degrees of positioning respective of one restraint element, and five degrees of positioning for two restraint elements. FIG. 4b depicts the one such design for such embodiments.

In some embodiments, the support elements (12) may be differentially rotationally resistant about an axis of the support element. For example, a support element (12) may be rotationally restrained in a first rotatable direction and more easily rotatable in a second rotatable direction. This condition of rotation may represent differentially resisting rotation. As depicted in FIG. 5, the support elements (12) may be restrained within restraint elements (20). Clamping elements (48) may be engaged to the support elements (12) in an engagement direction, as described above. In this preferred configuration, engagement of the clamp elements (14) to the support elements (12), and perhaps the engagement of the spline surface (52) to the plurality of splines (16), resists rotation of the support element. As the clamp element(s) (48) respond to the adjustment element (24), and in the embodiment above a rotational adjustment element, so as to lower the clamp resistance or reduce the clamp force, rotation of the support element may be facilitated. However, spline surface or elements (52) may be differentially positioned relative to splines (16), for example the spline surface comprising spline elements may be oriented in a non-tangential position relative to the support element and splines (16), such that rotation in a first rotation direction may be restrained. At the same time, however, the same orientation of splines may facilitate rotation in a second direction. Therefore, the differences in rotation with regard to rotation direction may characterize the support elements as differentially rotationally resistant. In accordance with particular embodiments, the level of engagement of the clamping element, or the particular configurations of the splines (16) and spline surface or elements (52), may prevent rotation in a particular rotation direction. Therefore, the present invention may even provide for a moveable differentially rotation resistant clamp element (14).

An additional aspect of the present invention may provide for a biasing of the clamp element(s) (14) (potentially also referred more generically throughout as an engagement element). This aspect may provide for biasing compressionally through compression elements (66) in accordance with particular configurations such as that of the support clamp (10). Biasing of the clamp element(s) (14) may be provided such that the clamp elements are biased either in an engagement direction of the clamp elements, as described above, or biasing the clamp elements in a direction substantially opposite to the engagement direction. In accordance with some embodiments of the present invention, the biasing provided by compression elements (66) may allow for compressional biasing. In some embodiments, the compressional biasing of the clamp elements may be in a direction opposite to the engagement direction while in others it may be opposite to the engagement direction. Opposite engagement-direction configurations of biasing can facilitate the rotation of support elements in two aspects: by having the clamp elements biased away from the support elements, and by reducing clamp force of the adjustment element (24) by the bias element(s) (66). This configuration is depicted in FIG. 5, wherein the compression or bias elements (66) are located in a position between the clamp element and the restraint element.

The biased engagement of the clamp elements may also be maintained upon a reduction in the clamp force. This particular configuration provides for bias or compression elements (66) positioned external from a location between the clamp element and the restraint element. The spring facilitates and engagement in the engagement direction, despite the potential reduction in clamp force that may be initiated by the adjustment element (24). This can facilitate the differential rotation feature discussed above.

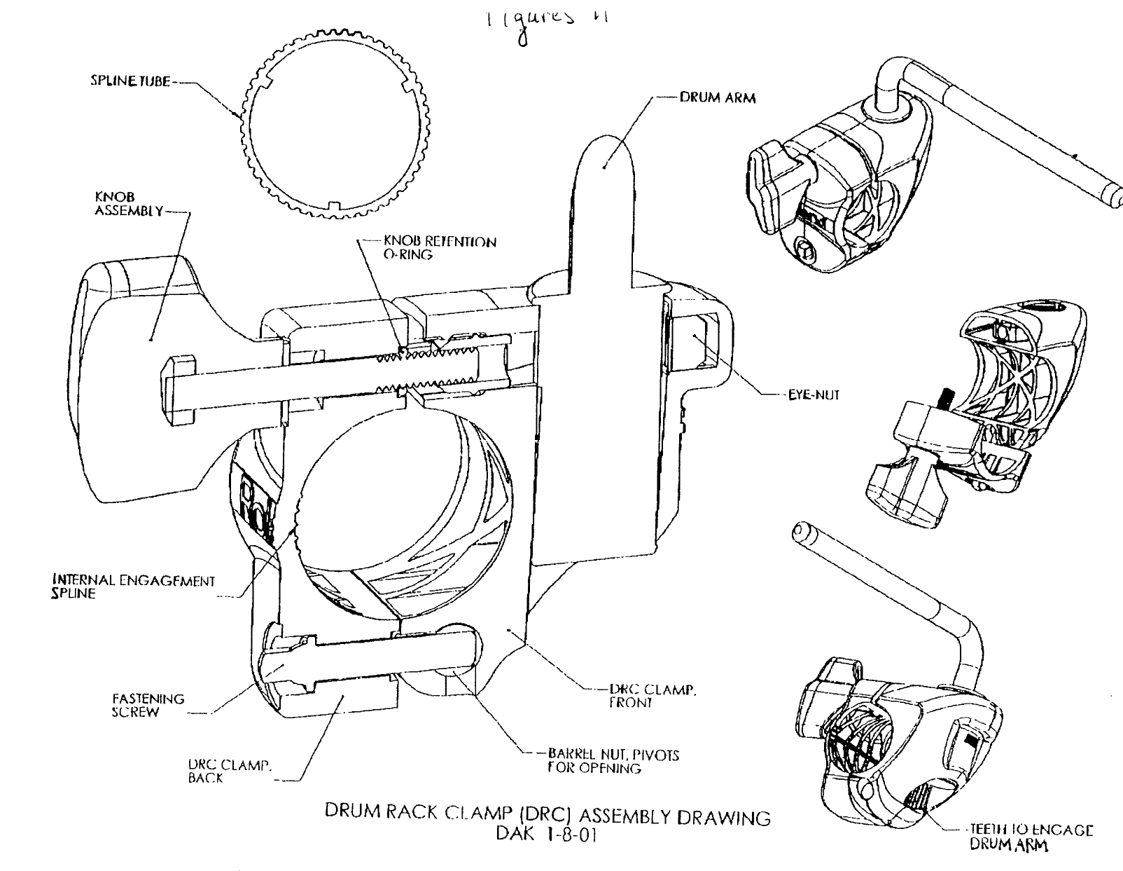

FIG. 11 depicts an additional design of potential interest. More particularly, a clamp system, both apparatus and the resulting methods thereof, are disclosed wherein a restraint element, or in particular a DRC Clamp, is provided comprising, in an embodiment, a retention element comprising a knob assembly and a screw bolt member, and an internal restraint element surface comprising, at least one or a plurality of internal spline engagement elements. Unlike embodiments of the above invention, the clamp may, in one embodiment, pivotally open, preferably about at least one barrel nut, and a support element, such as a spline tube, may be placed adjacent the restraint element. The restraint element may then be closed and the retention element adjusted such that the internal spline engagement elements may engage splines of the support element or tube. An additional fastening element may be provided to secure the restraint element.

As can be easily understood from the foregoing, the basic concepts of the present invention may be embodied in a variety of ways. It involves both clamping techniques as well as devices to accomplish clamping. In this application, the clamping techniques may be disclosed explicitly and as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of an “engagement element” should be understood to encompass disclosure of the act of “engaging”—whether explicitly discussed or not—and, conversely, were there effectively disclosure of the act of “engaging”, such a disclosure should be understood to encompass disclosure of an “engagement element” and even a “means for engaging”. Such changes and alternative terms are to be understood to be explicitly included in the description.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the Information Disclosure Citation or other information statement filed with the application are hereby appended and hereby incorporated by reference. However, as to each of the above, to the extent that such information or statements incorporated by reference might be considered inconsistent with the patenting of this/these invention(s) such statements are expressly not to be considered as made by the applicant(s).

Finally, when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

What is claimed is:

1 A support clamp, comprising:
a. at least one fixed restraint element having a central axis;
b. at least one adjustment element proximate said at least one fixed restraint element; and
c. at least one continuously parallel surface movable clamp element responsive to said adjustment element wherein a continuously parallel surface is substantially parallel to said central axis of said at least one fixed restraint element.

2 A support clamp as described in claim 1 wherein said fixed restraint element is unitary.

3 A support clamp as described in claim 1 or 2 wherein said restraint element comprises at least one tubular restraint.

4 A support clamp as described in claim 1 or 2 wherein said restraint element comprises a substantially encompassing restraint body to which a support element may be substantially encompassed.

5 A support clamp as described in claim 1 wherein said support element is integrally responsive with at least one support device, wherein said support device is a device selected from a group consisting of a music instrument stand, a music instrument rack, a shelf, a desk, a bicycle stand, a dental rack, and a dental stand.

6 A support clamp as described in claim 1 wherein said clamp element is an element selected from a group consisting of a clamp block and a clamp wedge.

7 A support clamp as described in claim 6 wherein said clamp element is an element selected from a group consisting of a triangular cross section, a polygonal cross section, a circular cross section, an oval cross section, and an ellipse cross section.

8 A support clamp as described in claim 1 wherein said clamp element is an element selected from a group consisting of a triangular cross section, a polygonal cross section, a circular cross section, an oval cross section, an ellipse cross section.

9 A support clamp as described in claim 1 wherein said clamp surface comprises at least one slope.

10 A support clamp as described in claim 9 wherein said slope corresponds to a portion of a circumferential shape, wherein said circumferential shape is a shape selected from a group consisting of a circle, triangle, oval, ellipse and polygon.

11 A support clamp as described in claim 1 wherein said clamp element comprises at least one spline surface corresponding to a plurality of splines of a support element.

12 A support clamp as described in claim 11 wherein said spline surface comprises at least one spline element, said spline element selected from a group consisting of a spline shape, a ridge and a tooth.

13 A support clamp as described in claim 1 wherein said clamp element is at least partially internal to said at least one restraint element

14 A support clamp as described in claim 1 wherein said at least one restraint element comprises a plurality of restraint elements and wherein each restraint element is individually angularly positioned.

15 A support clamp as described in claim 14 wherein said plurality of restraint elements correspond to a plurality of support elements and wherein one support element is positioned proximate to each restraint element and wherein each support element is angularly positioned.

16 A support clamp as described in claim 1 wherein said at least one restraint element comprises two restraint elements and wherein each of said restraint element are individually angularly positioned.

17 A support clamp as described in claim 16 wherein said two restraint elements correspond to two support elements and wherein one support element is positioned proximate to a restraint element and wherein each support element is individually angularly positioned.

18 A support clamp as described in claim 16 wherein each restraint element comprises a plurality of index elements corresponding to a plurality of index elements of other restraint elements.

19 A support clamp as described in claim 18 wherein said plurality of index elements comprises radially positioned teeth.

20 A support clamp as described in claim 18 wherein said plurality of index elements comprises elements indexed in angled gradations.

21 A support clamp as described in claim 18 wherein said plurality of index elements comprises elements indexed in coordinated increments.

22 A support clamp as described in claim 1 wherein said clamp element comprises two clamp elements and said restraint element comprises two restraint elements, wherein a first clamp element is positionally responsive substantially parallel to a central axis of a first restraint element and a second clamp element is positionally responsive substantially parallel to a central axis of a second restraint element.

23 A support clamp as described in claim 22 wherein each said clamp element is linearly responsive to said adjustment element.

24 A support clamp as described in claim 22 wherein said central axis of each restraint element comprises an axis of symmetry of each restraint element.

25 A support clamp as described in claim 22 wherein said at least one adjustment element is at least partially internal to at least one restraint element.

26 A support clamp as described in claim 1 wherein said clamp element is linearly responsive to said adjustment element.

27 A support clamp as described in claim 1 wherein said adjustment element comprises an axially unrestrained axial adjustment element.

28 A support clamp as described in claim 1 wherein said central axis is an axis of symmetry of said restraint element.

29 A support clamp as described in claim 1 wherein said at least one adjustment element is at least partially internal to said at least one restraint element.

30 A support clamp as described in claim 1 wherein said adjustment element comprises a plurality of adjustment elements.

31 A support clamp as described in claim 1 wherein said adjustment element is substantially internal to said restraint element.

32 A support clamp as described in claim 1 further comprising a support element adjacent said clamp element, wherein said support element is differentially rotationally resistant about an axis of said support element.

33 A support clamp as described in claim 1 wherein said clamp element is responsive to said adjustment element so as to be engagable with a support element in an engagement direction.

34 A support clamp as described in claim 33 further comprising at least one bias element responsive to said adjustment element and proximate said clamp element such that said clamp element is biased in a direction substantially opposite to said engagement direction.

35 A support clamp as described in claim 33 further comprising at least one bias element responsive to said adjustment element and proximate said clamp element such that said clamp element is biased in said engagement direction.

36 A support clamp as described in claim 34 or 35 wherein said clamp element is compressionally biased.

37 A support clamp as described in claim 34 wherein said clamp element is biasingly engaged with said support element and wherein support element is rotationally restrained in a first rotation direction about an axis of said support element and rotatable in a second rotation direction about an axis of said support element.

38 A support clamp as described in claim 37 wherein said support element is rotationally fixed from rotation in said first rotation direction.

39 A support clamp as described in claim 37 wherein said clamp element is responsive to said adjustment element such that a clamp force on said clamp element in a direction of said engagement direction is reduced.

40 A support clamp as described in claim 34 wherein said bias element comprises at least one compression element.

41 A support clamp as described in claim 35 wherein said bias element comprises at least one compression element.

42 A support clamp as described in claim 40 wherein at least one compression element is positioned at a distal end of said adjustment element and positioned external of a location between said clamp element and said restraint element.

43 A support clamp as described in claim 41 wherein at least one compression element is positioned between said clamp element and said restraint element.

44 A support clamp as described in claim 1 further comprising a restraint member at a distal end of said adjustment element.

45 A support clamp as described in claim 1 wherein said adjustment element comprises said rotational adjustment element.

46 A support clamp as described in claim 42 or 43 wherein said at least one compression element comprises two compression elements at distal ends of said adjustment element and wherein said at least one clamp element comprises two clamp elements and wherein said at least one restraint element comprises two restraint elements.

47 A support clamp as described in claim 1 wherein said clamp element is forcibly responsive to a translation element in a substantially radial direction of a central axis of said restraint element.

48 A support clamp as described in claim 47 wherein said clamp element comprises two clamp elements and wherein said restraint element comprises two restraint elements, wherein a first clamp element is forcibly responsive to a translation element in a substantially radial direction of a central axis of a first restraint element and a second clamp element is forcibly responsive to a translation element in substantially radial direction of a central axis of a second restraint element.

49 A support clamp as described in claim 48 further comprising two support elements, a first support element adjacent said first restraint element and said first clamp element, a second support element adjacent said second restraint element and said second clamp element, wherein each clamp element is forcibly responsive to a translation element in a substantially radial direction of a central axis of said support element.

50 A support clamp as described in claim 49 wherein said support element is integrally responsive with at least one support device, wherein said support device is a device selected from a group consisting of a music instrument stand, a music instrument rack, a shelf, a desk, a bicycle stand, a dental rack, a dental stand.

51 A support clamp as described in claim 47 wherein said clamp element is responsive to said translation element in a substantially radial direction of a central axis of a position element.

52 A support clamp as described in claim 47 wherein said translation element comprises a volume having a cross section selected from a group consisting of a triangular cross section, a polygonal cross section, a cylindrical cross section, oval cross section, and an elliptical cross section.

53 A support clamp as described in claim 47 wherein said translation element comprises a cross section of decreasing area.

54 A support clamp as described in claim 53 wherein said translation element comprises a ramp element.

55 A support clamp as described in claim 53 wherein said translation element comprises a cross section of decreasing area along a central axis of said translation element intersecting an axis of said adjustment element.

56 A support clamp as described in claim 32 further comprising at least one translation element to which said clamp element is forcibly responsive and wherein said clamp element is linearly responsive to said translation element in a decreasing substantially radial position from said central axis of said restraint element from one distal end of said translation element to a second distal end.

57 A method of clamping a support, comprising:
a. providing a support element proximate at least one fixed restraint element and at least one continuously parallel surface movable clamp element;
b. continuously parallely adjusting a position of said at least one continuously parallel surface movable clamp element with at least one adjustment element wherein said at least one continuously parallel surface movable clamp element is positionally responsive to said adjustment element with a continuously parallel surface substantially parallel to a central axis of said at least one fixed restraint element;
c. engaging said at least one continuously parallel clamp element to said support element,
d. positionally restraining said support element with said at least one continuously parallel clamp element and said at least one fixed restraint element.

58 A method of clamping a support as described in claim 57 wherein said step of positionally restraining said support element with said at least one continuously parallel clamp element and said at least one fixed restraint element comprises unitarily restraining said support element with said restraint element.

59 A method of clamping a support as described in claim 57 or 58 wherein said step of positionally restraining said support element with said at least one continuously parallel clamp element and said at least one fixed restraint element comprises tubularly restraining with said restraint element.

60 A method of clamping a support as described in claim 57 or 58 wherein said step of positionally restraining said support element with said at least one continuously parallel clamp element and said at least one fixed restraint element comprises substantially encompassing said support element with said fixed restraint element.

61 A method of clamping a support as described in claim 60 wherein said step of substantially encompassing said support element with said fixed restraint element comprises substantially encompassing with said fixed restraint support element wherein said support element is integrally responsive with at least one support device, and wherein said support device is a device selected from a group consisting of a music instrument stand, a music instrument rack, a shelf, a desk, a bicycle stand, a dental rack, and a dental stand.

62 A method of clamping a support as described in claim 57 wherein said step of positionally restraining said support element with said at least one continuously parallel clamp element and said at least one fixed restraint element comprises the step of positionally restraining with a clamp element selected from a group consisting of a clamp block and a clamp wedge.

63 A method of clamping a support as described in claim 57 wherein engaging said at least one continuously parallel clamp element to said support element comprises engaging a continuously parallel surface movable clamp element having a cross section selected from a group consisting of a triangular cross section, a polygonal cross section, a circular cross section, a oval cross section, and an elliptical cross section.

64 A method of clamping a support as described in claim 63 wherein engaging said at least one continuously parallel clamp element to said support element comprises engaging at least one slope of said at least one continuously parallel clamp element to said support element.

65 A method of clamping a support as described in claim 64 wherein engaging at least one slope comprises engaging at least one slope corresponding to portion of a circumferential shape selected from a group consisting of a circle, triangle, oval, ellipse and polygon.

66 A method of clamping a support as described in claim 57 wherein said step of engaging at least one continuously parallel surface movable clamp element to said support element comprises engaging at least one spline surface corresponding to a plurality of splines of said support element.

67 A method of clamping a support as described in claim 66 wherein engaging at least one spline surface comprises engaging at least one engagement element with said support element, said engagement element selected from a group consisting of a spline, ridge and tooth.

68 A method of clamping a support as described in claim 57 or 62 wherein continuously parallely adjusting a position of said at least one continuously parallel surface movable clamp element with at least one adjustment element comprises adjusting a position of said at least one continuously parallel surface movable clamp element from a position at least partially internal to said at least one restraint element.

69 A method of clamping a support as described in claim 57 wherein said at least one fixed restraint element comprises a plurality of fixed restraint elements and further comprising the step of individually angularly positioning each fixed restraint element.

70 A method of clamping a support as described in claim 69 further comprising steps of:
a. providing a plurality of support elements corresponding to said plurality of fixed restraint elements, wherein one support element is positioned proximate to one restraint element; and
b. individually angularly positioning each support element.

71 A method of clamping a support as described in claim 57 wherein said at least one fixed restraint element comprises two fixed restraint elements and further comprising step of individually angularly positioning each fixed restraint element.

72 A method of clamping a support as described in claim 71 further comprising the steps of:
a. providing two support elements corresponding to said two fixed restraint elements, wherein one support element is positioned proximate to one fixed restraint element; and
b. individually angularly positioning each support element.

73 A method of clamping a support as described in claim 69 or 71 further comprising the step of individually angularly indexing a position of each fixed restraint element.

74 A method of clamping a support as described in claim 73 wherein said step of individually angularly indexing a position of each fixed restraint element comprises indexing in angle gradations.

75 A method of clamping a support as described in claim 73 wherein step of individually angularly indexing a position of each fixed restraint element comprises angularly indexing a position each said fixed restraint element in coordinated increments.

76 A method of clamping a support as described in claim 57 wherein said at least one continuously parallel surface movable clamp element comprises two clamp elements and said at least one fixed restraint element comprises two fixed restraint elements and wherein said step of adjusting comprises the steps of:
a. adjusting a position of a first clamp element, wherein said first clamp element is positionally responsive substantially parallel to a central axis of a first fixed restraint element; and
b. adjusting a position of a second clamp element, wherein said second clamp element is positionally responsive substantially parallel to a central axis of a second fixed restraint element.

77 A method of clamping a support as described in claim 76 wherein said steps of adjusting first and second clamp elements comprises adjusting said clamp elements such that each clamp element is linearly responsive to said adjustment element.

78 A method of clamping a support as described in claim 76 wherein steps of adjusting first and second clamp elements comprises adjusting said clamp elements such that said first clamp element is positionally responsive to said adjustment element substantially parallel to an axis of symmetry of said first restraint element and said second clamp element is positionally responsive to said adjustment element substantially parallel to an axis of symmetry of second restraint element.

79 A method of clamping a support as described in claim 79 wherein said steps of adjusting a position of said first and second clamp elements with at least one adjustment element comprises adjusting a position of said clamp elements from a position at least partially internal to at least one of said restraint elements.

80 A method of clamping a support as described in claim 57 wherein step of continuously parallely adjusting a position of said at least one continuously parallel surface movable clamp element with at least one adjustment element comprises adjusting said at least one continuously parallel surface movable clamp element such that said clamp element is linearly responsive to said adjustment element.

81 A method of clamping a support as described in claim 80 further comprising axially responding said adjustment element to said step of adjusting a position of said at least one continuously parallel surface movable clamp element such that said adjustment element is axially unrestrained.

82 A method of clamping a support as described in claim 57 wherein step of adjusting a position of said at least one continuously parallel surface movable clamp element comprises adjusting said continuously parallel surface movable clamp element such that said clamp element is positionally responsive to said adjustment element substantially parallel to an axis of symmetry of said at least one fixed restraint element.

83 A method of clamping a support as described in claim 57 wherein step of adjusting a position of said at least one continuously parallel surface movable clamp element comprises adjusting a position of said clamp element from a position at least partially internal to at least one fixed restraint element.

84 A method of clamping a support as described in claim 57 or 80 wherein said step of adjusting a position of said at least one continuously parallel surface movable clamp element with at least one adjustment element comprises adjusting a position of said clamp element with a plurality of adjustment elements.

85 A method of clamping a support as described in claim 57 or 80 wherein said step of adjusting a position of said at least one continuously parallel surface movable clamp element with at least one adjustment element comprises adjusting a position of said clamp element from a position substantially internal to at least one fixed restraint element.

86 A method of clamping a support as described in claim 57 further comprising the step of differentially resisting rotation of said support element about an axis of said support element.

87 A method of clamping a support as described in claim 57 wherein step of engaging said at least one continuously parallel clamp element to said support element comprises engaging said clamp element to said support element in an engagement direction.

88 A method of clamping a support as described in claim 87 further comprising the step of biasing said at least one continuously parallel clamp element in a direction opposite to said engagement direction.

89 A method of clamping a support as described in claim 87 further comprising the step of biasing said at least one continuously parallel clamp element in said engagement direction.

90 A method of clamping a support as described in claim 88 or 89 wherein said step of biasing said at least one continuously parallel clamp element comprises compressionally biasing.

91 A method of clamping a support as described in claim 88 further comprising the steps of:
a. maintaining a biased engagement of said at least one continuously parallel clamp element with said support element;
b. rotationally restraining said support element in a first rotation direction about an axis of said support element; and
c. facilitating rotation in a second rotation direction about an axis of said support element.

92 A method of clamping a support as described in claim 91 wherein said step of rotationally restraining said support element in a first rotation direction about an axis of said support element comprises preventing rotation in said first rotation direction about an axis of said support element.

93 A method of clamping a support as described in claim 91 further comprising a step of reducing a clamp force on said at least one continuously parallel clamp element in a direction of said engagement direction.

94 A method of clamping a support as described in claim 57 wherein said step of continuously parallely adjusting a position of said at least one continuously parallel surface movable clamp element comprises the step of translating said at least one at least one clamp element in a substantially radial direction of a central axis of said at least one fixed restraint element.

95 A method of clamping a support as described in claim 94 wherein said at least one continuously parallel clamp element comprises two clamp elements and wherein said at least one fixed restraint element comprises two fixed restraint element and further comprising the steps of:
a. translating a first clamp element along a first clamp element guide and forcibly responding said first clamp element in a substantially radial direction of a central axis of said first fixed restraint element; and
b. translating a second clamp element along a second clamp element guide and forcibly responding said second clamp element in a substantially radial direction of a central axis of said second fixed restraint element.

96 A method of clamping a support as described in claim 95 further comprising the steps of:
a. providing two support elements, a first support element adjacent said first restraint element and said first clamp element, a second support element adjacent said second restraint element and said second clamp element; and
b. translating each clamp element along a clamp element guide and forcibly responding said clamp element in a substantially radial direction of a central axis of said support element.

97 A method of clamping a support as described in claim 94 further comprising the steps of:
a. providing at least one support element adjacent said at least one fixed restraint element and said at least one clamp element; and
b. translating said clamp element in a substantially radial direction of a central axis of said at least one support element.

98 A method of clamping a support as described in claim 97 wherein said step of providing at least one support element comprises providing at least one support element integrally responsive with at least one support device, wherein said support device is a device selected from a group consisting of a music instrument stand, a music instrument rack, a shelf, a desk, a bicycle stand, a dental rack, and a dental stand.

99 A method of clamping a support as described in claim 94 wherein said step of translating said at least one clamp element comprises translating said at least one clamp element along a translation element, said translation element having a volume with a cross section, wherein said cross section is selected from a group consisting of a triangular a cross section, a polygonal cross section, a circular cross section, an oval cross section, and an elliptical cross section.

100 A method of clamping a support as described in claim 94 wherein said step of translating said at least one clamp element comprises translating said at least one clamp element along a translation volume having a cross section of decreasing area.

101 A method of clamping a support as described in claim 100 wherein said step of translating said at least one clamp element along a translation element comprises translating said at least one clamp element along a ramp element.

102 A method of clamping a support as described in claim 100 wherein said step of translating said at least one clamp element further comprises the step of translating said at least one clamp element along a central axis of said translation element intersecting an axis of said adjustment element.

103 A method of clamping a support as described in claim 80 further comprising the step of translating said clamp element along at least one translation element, and wherein said at least one clamp element is forcibly responsive to said at least one translation element in a decreasing substantially radial position from said central axis of said at least one fixed restraint element from one distal end of said translation element to a second end proximate said central axis.

104 A method of multidirectional support clamping, comprising:
a. providing a support element proximate at least one fixed restraint element and at least one movable clamp element;
b. adjusting a position of said at least one movable clamp element with at least one adjustment element;
c. engaging said at least one movable clamp element to said support element,
d. positionally restraining said support element with said at least one movable clamp element and said at least one fixed restraint element;
f. maintaining engagement of said at least one clamp element to said support element; and
g. differentially resisting rotation of said support element about an axis of said support element.

105 A method of multidirectional support clamping as described in claim 104 wherein said step of adjusting a position of said at least one movable clamp element with at least one adjustment element comprises continuously parallely adjusting a position of said at least one movable clamp element.

106 A method of multidirectional support clamping as described in claim 105 further comprising the step of positionally responding said at least one continuously parallel surface movable clamp element to said adjustment element, and wherein said at least one clamp element comprises a continuously parallel surface substantially parallel to a central axis of said at least one fixed restraint element.

107 A method of multidirectional support clamping as described in claim 104 further comprising the step of adjustably positioning a support element adjacent said at least one moveable clamp element in at least three degrees of position.

108 A method of multidirectional support clamping as described in claim 104 further comprising the step of adjustably positioning a support element adjacent said at least one moveable clamp element in at least five degrees of position.

109 A method of multidirectional support clamping as described in claim 104, 107 or 108 further comprising the step of biasing said at least one movable clamp element in a direction opposite to an engagement direction.

110 A method of multidirectional support clamping as described in claim 104, 107 and 108 further comprising the step of biasing said at least one movable clamp element in an engagement direction.

111 A method of multidirectional support clamping as described in claim 109 or 110 wherein said step of biasing said at least one movable clamp element comprises the step of compressionally biasing.

112 A method of multidirectional support clamping as described in claim 109 further comprising the steps of:
a. maintaining a biased engagement of said at least one clamp element with said support element;
b. rotationally restraining said support element in a first rotation direction about an axis of said support element; and
c. facilitating rotation in a second rotation direction about an axis of said support element.

113 A method of multidirectional support clamping as described in claim 112 wherein said step of rotationally restraining said support element in a first rotation direction about an axis of said support element comprises preventing rotation in said first rotation direction about an axis of said support element.

114 A method of multidirectional support clamping as described in claim 1 12 further comprising the step of reducing a clamp force on said at least one clamp element in a direction of said engagement direction.

115 A method of multidirectional support clamping as described in claim 104 and wherein said at least one movable clamp element is selected from a group consisting of a clamp block and a clamp wedge.

116 A method of multidirectional support clamping as described in claim 104 wherein the step of engaging said at least one movable clamp element to said support element comprises engaging at least one movable clamp element having a cross section, and wherein said cross section is selected from a group consisting of a triangular cross section, a polygonal cross section, a circular cross section, an oval cross section, and an elliptical cross section.

117 A method of multidirectional support clamping as described in claim 116 wherein the step of engaging said at least one continuously parallel surface movable clamp element comprises engaging at least one slope of said at least one continuously parallel surface moveable clamp element to said support element.

118 A method of multidirectional support clamping as described in claim 117 wherein the step of engaging at least one slope of said at least one continuously parallel surface moveable clamp element to said support element comprises engaging at least one slope corresponding to a portion of a circumferential shape, said circumferential shape selected from a group consisting of a circle, an oval, an ellipse and a polygon.

119 A method of multidirectional support clamping as described in claim 104 wherein the step of engaging at least one movable clamp element to said support element comprises engaging at least one spline surface corresponding to a plurality of splines of said support element.

120 A method of multidirectional support clamping as described in claim 119 wherein the step of engaging at least one spline surface comprises engaging at least one engagement element to said support element, said engagement element selected from a group consisting of a spline shape, a ridge and a tooth.

121 A method of multidirectional support clamping as described in claim 104 or 115 wherein the step of adjusting a position of said at least one moveable clamp element with at least one adjustment element comprises adjusting a position of said at least one moveable clamp element from a position at least partially internal to said at least one restraint element.

122 A method of multidirectional support clamping as described in claim 104, 107 or 108 wherein said at least one fixed restraint elements comprises a plurality of fixed restraint elements and further comprising the step of individually angularly positioning each restraint element.

123 A method of multidirectional support clamping as described in claim 122 further comprising the steps of:
a. providing a plurality of support elements corresponding to said plurality of fixed restraint elements, wherein each support element is positioned proximate to a fixed restraint element; and
b. individually angularly positioning each support element.

124 A method of multidirectional support clamping as described in claim 104 wherein said at least one fixed restraint element comprises two fixed restraint elements and further comprising the step of individually angularly positioning each fixed restraint element.

125 A method of multidirectional support clamping as described in claim 124 further comprising the steps of:
a. providing two support elements corresponding to said two fixed restraint elements, wherein each support element is positioned proximate to a fixed restraint element; and
b. individually angularly positioning each support element.

126 A method of multidirectional support clamping as described in claim 122 or 124 further comprising the step of individually angularly indexing a position of each fixed restraint element.

127 A method of multidirectional support clamping as described in claim 126 wherein said step of individually angularly indexing comprises indexing in angle gradations.

128 A method of multidirectional support clamping as described in claim 126 wherein said step of individually angularly indexing comprises angularly indexing a position in coordinated increments.

129 A support clamp, comprising:
a. at least one fixed restraint element;
b. at least one adjustment element proximate said at least one fixed restraint element;
c. at least one moveable differentially rotation resistant clamp element responsive to said adjustment element.

130 A support clamp as described in claim 129 wherein at least one moveable differentially rotation resistant clamp element comprises at least one continuously parallel surface.

131 A support clamp as described in claim 130 wherein said at least one continuously parallel surface is substantially parallel to a central axis of said at least one fixed restraint element.

132 A support clamp as described in claim 129 providing at least three degrees of adjustable positioning for a support element adjacent said at least one moveable differentially rotation resistant clamp element.

133 A support clamp as described in claim 129 providing at least five degrees of adjustable positioning for a support element adjacent said at least one moveable differentially rotation resistant clamp element.

134 A support clamp as described in claim 129, 130 or 133 further comprising a support element adjacent said at least one moveable differentially rotation resistant clamp element, and wherein said support element is differentially rotation resistant about an axis of said support element.

135 A support clamp as described in claim 129 further comprising at least one bias element responsive to said at least one adjustment element and proximate said at least one moveable differentially rotation resistant clamp element such that said at least one clamp element is biased in a direction substantially opposite to an engagement direction.

136 A support clamp as described in claim 129 further comprising at least one bias element responsive to said at least one adjustment element and proximate said at least one moveable differentially rotation resistant clamp element such that said at least one clamp element is biased in an engagement direction.

137 A support clamp as described in claim 135 wherein said at least one moveable differentially rotation resistant clamp element is biasingly engaged with said support element and wherein said support element is rotationally restrained in a first rotation direction about an axis of said support element and rotatable in a second rotation direction about an axis of said support element.

138 A support clamp as described in claim 137 wherein said support element is prevented from rotation in said first rotation direction.

139 A support clamp as described in claim 137 wherein said at least one moveable differentially rotation resistant clamp element is responsive to said at least one adjustment element such that a clamp force on said at least one clamp element in a direction of said engagement direction is reduced.

140 A support clamp as described in claim 135 wherein said at least one bias element comprises at least one compression element.

141 A support clamp as described in claim 136 wherein said at least one bias element comprises at least one compression element.

142 A support clamp as described in claim 140 wherein said at least one compression element is positioned at a distal end of said at least one adjustment element and positioned external of a location between said at least one moveable differentially rotation resistant clamp element and said at least one restraint element.

143 A support clamp as described in claim 141 wherein at least one compression element is positioned between said at least one moveable differentially rotation resistant clamp element and said at least one restraint element.

144 A support clamp as described in claim 129, 135 or 136 further comprising a restraint member at a distal end of said at least one adjustment element.

145 A support clamp as described in claim 129, 135 or 136 wherein said at least one adjustment element comprises a rotational adjustment element.

146 A support clamp as described in claim 142 or 143 wherein said at least one compression element comprises two compression elements at distal ends of said at least one adjustment element and wherein said at least one moveable differentially rotation resistant clamp element comprises two clamp elements and wherein said at least one restraint element comprises two restraint elements.

147 A support clamp as described in claim 129 wherein said at least one moveable differentially rotation resistant clamp element is selected from a group consisting of a clamp block and a clamp wedge.

148 A support clamp as described in claim 130 wherein said at least one moveable differentially rotation resistant clamp element comprises a cross section selected from a group consisting of a triangular cross section, a polygonal cross section, a circular cross section, an oval cross section, and an elliptical cross section.

149 A support clamp as described in claim 129 wherein said at least one moveable differentially rotation resistant clamp element comprises a cross section selected from a group consisting of a triangular cross section, a polygonal cross section, a circular cross section, an oval cross section, and an elliptical cross section.

150 A support clamp as described in claim 129 wherein said at least one moveable differentially rotation resistant clamp surface comprises at least one slope.

151 A support clamp as described in claim 150 wherein said at least one slope corresponds to a portion of a circumferential shape, said circumferential shape selected from a group consisting of a circle, an oval, an ellipse and a polygon.

152 A support clamp as described in claim 129 wherein said at least one moveable differentially rotation resistant clamp element comprises at least one spline surface corresponding to a plurality of splines of a support element.

153 A support clamp as described in claim 152 wherein said at least one spline surface comprises at least one spline element selected from a group consisting of a spline shape, a ridge and a tooth.

154 A support clamp as described in claim 129 or 130 wherein said at least one moveable differentially rotation resistant clamp element is at least partially internal to said at least one restraint element.

155 A support clamp as described in claim 129 wherein said at least one restraint element comprises a plurality of restraint elements and wherein each of said restraint elements are individually angularly positioned.

156 A support clamp as described in claim 155 wherein said plurality of restraint elements correspond to a plurality of support elements and wherein each support element is positioned proximate to one restraint element and wherein each support element is angularly positioned.

157 A support clamp as described in claim 129, 130 or 133 wherein said at least one restraint element comprises two restraint elements and wherein each of said restraint elements are individually angularly positioned.

158 A support clamp as described in claim 157 wherein said at least two restraint elements correspond to two support elements and wherein each support element is positioned proximate to a restraint element and wherein each support element is individually angularly positioned.

159 A support clamp as described in claim 157 wherein each restraint element comprises a plurality of index elements corresponding to a plurality of index elements of the other restraint elements.

160 A support clamp as described in claim 159 wherein said plurality of index elements comprises radially positioned teeth.

161 A support clamp as described in claim 159 wherein said plurality of index elements comprises elements indexed in angle gradations.

162 A support clamp as described in claim 159 wherein said plurality of index elements comprises elements indexed in coordinated increments.
